(19) United States
(12) Patent Application Publication
(10) Pub. No.: US 2009/0203535 A1
(43) Pub. Date: Aug. 13, 2009

(54) ACOUSTIC WAVE TRANSDUCER SUBSTRATE AND MEASUREMENTS USING THE SAME

(75) Inventors: Mark Welland, Cambridgeshire (GB); Christopher Dobson, Cambridgeshire (GB); Tuomas Knowles, Cambridgeshire (GB)

Correspondence Address: Leason Ellis LLP, 81 Main Street, Suite 503, White Plains, NY, 10601, US

(73) Assignee: CAMBRIDGE ENTERPRISE LIMITED, Cambridge (GB)

(21) Appl. No.: 12/299,408

(22) PCT Filed: May 11, 2007
(86) PCT No.: PCT/GB2007/001749

§ 371 Date: Nov. 3, 2008

(30) Foreign Application Priority Data
May 11, 2006 (GB) 0609382.7

(51) Int. Cl. C40B 30/04; C40B 60/14; C40B 50/18

(52) U.S. Cl. 506/9; 506/40; 506/32

(57) ABSTRACT

An acoustic wave transducer substrate is provided, the substrate having a surface with a plurality of growth promotion sites for promoting the accumulation of polypeptide molecules at said sites. The growth-promotion sites are preferably for promoting fibril formation. The invention also provides a method of screening a candidate compound for an effect on fibril growth, including the steps of: providing an acoustic wave transducer substrate having a surface with a plurality of growth promotion sites for promoting the accumulation of polypeptide molecules at said sites; causing oscillation of the substrate; contacting the substrate surface with a sample fluid comprising polypeptide molecules and a candidate compound; and measuring one or more parameters of the substrate oscillation to monitor the accumulation of said polypeptide molecules of interest in the presence and absence of said candidate compound. Alteration of the accumulation of said polypeptide molecules of interest in the presence of said candidate compound as compared with that in the absence of said candidate compound indicates that the candidate compound has an effect of fibril growth.

The present invention is concerned with acoustic wave transducer substrates and measurements using such a substrate. Particularly, but not exclusively, the invention is concerned with measurement of amyloid fibril nucleation and/or growth using acoustic wave transducer substrates.

A range of human diseases have a common consequence in that during their development in the body they form a “plaque” of fibres of nanoscale mis-folded proteins, so called amyloid fibrils. The diseases with this pathology include Alzheimer's disease, Type II diabetes and Creutzfeldt-Jakob disease (the human analogue of Bovine Spongiform Encephalopathy, or mad cow disease).

In the discussion that follows, and in the discussion of the invention, the word “protein” is used to mean any polypeptide molecule comprising one or more chains each comprising a plurality of amino acids. Included within the meaning of protein are relatively short chains often referred to as “peptides”.

It is known that certain proteins have a propensity to associate into filamentous structures called fibrils. For example, amyloid fibrils are formed by the self-assembly of proteins into highly organised filamentous structures.

It is known that quartz crystal microbalance (QCM) devices can be used as biological sensors. A QCM device typically has a piezoelectric crystal sensor (e.g. quartz) with electrodes formed at the upper and lower surfaces of the crystal in order to apply an oscillating electric field to the crystal. Using a suitable alternating electric field, surface acoustic waves can be generated across the active surface of the sensor. As these surface waves traverse the surface region of the sensor, they undergo a shift in frequency and phase related to material bound at the surface. The shift in frequency is related to the mass attached to the surface. The shift in dissipation is related to non-elastic losses of material attached to the surface, e.g. viscous damping.

QCM devices have been used to carry out biological analysis of fluid samples in WO 99/30159. In this document, the surface of the QCM sensor was pre-treated so as to immobilise a receptor at the surface. A fluid sample containing a corresponding target molecule was contacted with the QCM sensor. The binding of the target molecule to the receptor was investigated by measuring changes in frequency of oscillation of the sensor and changes in the dissipation factor after switch-off of the sensor.

In WO 01/02857, the affinity between binding partners such as antigens and antibodies is investigated by immobilising one of the binding partners at a surface of a QCM sensor and increasing the amplitude of oscillation of the QCM sensor to dissociate the binding partners, this dissociation itself being sensed by the QCM sensor.

In US 2004/0235198, there are disclosed selective whole cell biosensors using QCM substrates. On the upper gold electrode of the QCM crystal is formed a monolayer of extracellular matrix material, or mimetics of such material. This allows the selection of whole cells to attach to the QCM sensor. The cells may then be exposed to test compounds during operation of the QCM sensor, in order to determine the effect of such test compounds on measurable aspects of the cells via QCM techniques.

Kawasaki et al (T. Kawasaki, K. Asaoka, H. Mihara and Y. Okahata, “Nonfibrous β-structures aggregation of an Aβ model peptide (Ad-2α) on GM1/DPPC mixed monolayer surfaces”, Journal of Colloid and Interface Science 294 (2006) 295-303) model the adsorption and aggregation of transformed peptides and proteins onto cell membrane surfaces by promoting adsorption of a model peptide onto a surface of a QCM substrate. A mixed layer of glycolipids (GM1, asialo-GM1, GM3, or LacCer) and dipalmitoyl phosphatidylcholine (DPPC) was transferred onto an Au electrode plate of a QCM to examine the dynamics of Ad-2α peptide bonding. The results show that the peptide adsorbs as a monolayer onto the QCM substrate surface, i.e. that amyloid fibrils are not formed.

The present inventors are interested in assessing the nucleation and/or growth of amyloid fibrils, particularly due to the indications that such structures provide in relation to disease development and progression. One known technique for assessing the growth of amyloid fibrils requires the attachment and detection of optical markers. This is described in: Nilson M. R, “Techniques to study amyloid fibril formation in vitro”, J. Mol. Biol. 2004 September; 34(1):151-60.

Another known technique uses light scattering. This is described in C. Shen, G. Scott, F. Merchant and R. Murphy, “Light scattering analysis of fibril growth from the amino-terminal fragment beta (1-28) of beta-amyloid peptide”, Biophys J. 1993 December; 65(6): 2383-2395. However, at best, light scattering can provide only semi-quantitative data on fibril extension rates.

Accordingly, in a first aspect, the present invention provides an acoustic wave transducer substrate having a surface with a plurality of growth promotion sites for promoting the accumulation of polypeptide molecules at said sites.

Accumulation of polypeptide molecules in this and all aspects of the invention may include association of a plurality of polypeptide molecules whether or not covalently linked. Accumulation of polypeptide molecules may for example involve hydrogen bonding. Accumulation preferably involves association of polypeptide molecules to form one or more fibrils. The growth promotion sites are preferably for promoting fibril formation.

By providing growth promotion sites, the invention allows more efficient monitoring of polypeptide molecule accumulation, including fibril growth.

Preferably, the acoustic wave transducer substrate is a QCM sensor. Typically, at least one surface of the substrate has a conducting layer (e.g. for use as an electrode). The growth promotion sites may be disposed directly on the conducting layer. A suitable conducting layer is gold.

Preferably, the polypeptide molecules of interest are capable of forming amyloid fibrils. In this case, the growth promotion sites may be provided with seed-fibrils, preferably immobilised at the surface of the substrate. Seed fibrils may comprise one or more amyloid fibrils comprising polypeptide molecules. The seed-fibrils may be caused to attach to the surface by simple adsorption. However, a number of mechanisms can be used to cause attachment. The seed-fibrils may comprise sulfhydryl groups, which groups bind to the substrate, such as the gold substrate. A seed fibril may be engineered to exhibit at least one sulfhydryl group on a solvent exposed side. In some cases the seed fibril will not require such engineering. For example, without being limited by theory, it is presently believed, as further described herein, that the adsorption of insulin fibrils involves binding of sulfhydryl groups present in the fibril to a gold substrate. Seed-fibrils may grow by the attachment of peptide “monomers” at the seed-fibril end or ends. Preferably, the seed-fibrils of interest lie prone on the substrate. Without being limited by theory, it is presently believed that due to maximisation of the interaction energy, the seed fibrils lie prone on the substrate surface, and shown by AFM investigation (described below). It will be understood that this does not exclude the possibility that some seed-fibrils will not assume this position, and instead will, to some extent, be upstanding from the substrate surface. However, the intention is that the useful measurement data will be determined to a large extent by the prone seed-fibrils, since these are more firmly attached to the substrate, and therefore their masses have a greater effect on the oscillation frequency of the substrate during oscillation than the loosely-bound upstanding fibrils.

Preferably, a barrier layer is provided on the substrate in spaces between the growth promotion sites. This barrier layer preferably has the effect of reducing or avoiding non-specific adsorption of peptides at the substrate surface. In this way, the measurements taken by operating the substrate can be more confidently attributed to growth processes occurring at the growth promotion sites. The barrier layer is preferably capable of selectively adsorbing to the substrate surface, such as a gold surface, and not the growth promotion sites, such as seed fibrils. In this way the barrier layer can be provided between the growth promotion sites by simply adding the barrier layer after the addition or formation of the growth promotion sites.

In the case where the substrate has a gold layer at the surface, the barrier layer preferably adsorbs to the gold layer via thiol groups. Preferably, the barrier layer is formed from a monolayer of polymer. Most preferably, the barrier layer is formed from poly(ethylene glycol) (PEG) having, for example, a thiol functional group formed at one end of the molecule. The other end of the molecule need not have a functional group, although it may.

Preferably, seed-fibrils located at the growth promotion sites and lying prone on the substrate grow by extension of one (or more) free end, typically onto the surface of the barrier layer. Thus, preferably the growing fibril adheres to the surface of the barrier layer so that the growing part of the fibril is immobilised sufficiently with respect to the substrate in order that the growth affects the frequency of oscillation of the substrate.

In the case where the growth promotion sites are provided with seed-fibrils, preferably these are of average length 1 μm or less, 500 nm or less, 400 nm or less, 300 nm or less, 200 nm or less or preferably about 100 nm average length. In order to provide seed-fibrils of a suitable length, fibrils may be fractured to the required length. In a suitable technique, a suspension of fibrils may be fractured by ultrasonication. Providing relatively short seed-fibrils in this way allows the number of free ends per unit mass of seed-fibrils to be increased, therefore increasing the number of available ends for the growth of fibrils, and therefore increasing the signal-to-noise ratio of the subsequent oscillation measurement (set out in greater detail below).

Preferably, the growth promotion sites are arranged in a regular array on the substrate surface. In the case where the growth promotion sites are provided with seed-fibrils, this may be achieved by patterning techniques. For example, a layer of seed-fibrils may be applied to the substrate, and the seed-fibrils located in areas between the growth-promotion sites may then be removed by lithography or another patterning technique. Alternatively, the seed-fibrils may be directly applied in the required array by contact-printing or another printing technique such as inkjet printing.

Preferably, the growth promotion sites are fixed. Based on AFM data it has been found that, once deposited, seed fibrils are fixed and do not move. The seed-fibrils are preferably distributed uniformly on the substrate. The uncovered areas can then be protected with a barrier layer.

The substrate may be provided with a seeding-controlling, growth-promotion or growth-controlling topography. For example, the substrate may be provided with an array of upstanding or depressed features at or adjacent to the growth promotion sites. In the case of seed-fibrils, such topography may promote, control and/or direct fibril growth. Additionally or alternatively, such topography may promote or control seeding of the growth promotion sites, e.g. by providing preferential locations for immobilisation of seed-fibrils. Preferably, the topography includes channels/grooves and/or ridges. Such features may be formed by known lithographic routes. The topography may be aligned from site to site, at least for a portion of the substrate. In this way, control may be exercised over the direction of the seed-fibrils and/or over the direction of growth of the seed fibrils. This may provide a suitable mechanism for investigating the real or imaginary mechanical response of the substrate oscillation as a function of fibril direction.

The differential signal from shear waves parallel and perpendicular to

the growing fibril axis may be used to obtain information on the mechanical
properties of the fibrils, and on the interaction energies with the
substrate.

The invention is not necessarily limited to the use of seed-fibrils. The growth-promotion sites of the substrate may be adapted to provide nucleation and growth of the polypeptide molecule of interest. The growth-promotion sites may be provided with an immobilised binding partner capable of specifically binding a polypeptide molecule of interest. The polypeptide molecule of interest is preferably capable of promoting fibril formation. A polypeptide molecule of interest may thereby be bound by the immobilised binding partner and serve as a seed for growth, such as fibril formation. For example, an immobilised binding partner may comprise an antibody or antibody fragment specific for a polypeptide molecule of interest.

Typically, electrodes are provided for causing suitable oscillation of the substrate. The surface area of the substrate probed by the oscillation may be termed the sensing area. The substrate may include more than one sensing area. Corresponding electrodes are typically provided for each sensing area. The nature of the growth promotion sites in one sensing area may be different to those in another. In particular, one sensing area may be for detecting the accumulation of different polypeptide molecules (including differences only in conformational state) compared with another. Alternatively, at least one of the sensing areas may be a control sensing area, without growth promotion sites. The number of sensing areas is not particularly limited, except by practical considerations such as arranging suitable electrical contacts for the necessary electrodes, as will be clear to the skilled person. There may be at least two, at least three, at least five, at least ten, at least twenty or more sensing areas. In use, different sensing areas may be operated at different times, in order that the signals from different sensing areas may be differentiated. However, preferably, at least some of the different sensing areas are operated at the same time, at slightly different frequencies. Use of suitable frequency-sensitive detection devices (e.g. lock-in amplifiers), the response of the different sensing areas can be differentiated.

The first aspect of the invention, and/or preferred/optional features of the first aspect may be combined in any combination with any other aspect of the invention, unless the context demands otherwise. Similarly, preferred/optional features of other aspects of the invention may be combined in any combination with the first aspect.

In a second aspect, the present invention provides a method of treating an acoustic wave transducer substrate in order to provide a plurality of growth promotion sites for promoting the growth of polypeptide molecules at said sites, the method including depositing seed-fibrils at said growth-promotion sites.

In a third aspect of the invention, there is provided a method of treating an acoustic wave transducer substrate in order to provide a plurality of growth promotion sites for promoting the growth of polypeptide molecules at said sites, the method including depositing binding partners specific for a polypeptide molecule of interest at said growth-promotion sites.

A barrier layer (e.g. as set out with respect to the first aspect) may be provided in the areas between the growth promotion sites. Preferably, the barrier layer is deposited after the formation of the growth promotion sites.

Preferably, the seed-fibrils are deposited at the growth promotion sites from a suspension of seed-fibrils. Preferably, the seed-fibrils adsorb onto the substrate surface over a time period of at least 10 minutes, preferably at least 30 minutes, more preferably about 60 minutes. It is preferred that the adsorption is carried out in a humidity-controlled environment. Preferably, the humidity-controlled environment has substantially 100% humidity. A humidity-controlled environment reduces or prevents evaporation. This minimises variation in the concentration of seed-fibrils in the solution over time. Preferably, the concentration of the seed-fibrils is substantially constant.

In a fourth aspect, the present invention provides an acoustic transducer substrate treatment apparatus including a deposition device for forming a plurality of growth promotion sites on a substrate, for promoting the accumulation of polypeptide molecules at said sites.

Preferably, the deposition device includes an inkjet printing mechanism, the “ink” to be used in said device being a suspension of seed-fibrils for adsorption at said growth promotion sites. Patterning may also be achieved by use of micro contact printing, using a printing member having an array of topographical features for contacting with the substrate to deposit seed-fibrils in a desired pattern.

It is envisaged that a substrate may be used more than once, by forming a first set of growth promotion sites for one test as set out above, carrying out the test, and subsequently removing the first set of growth promotion sites (e.g. via a solvent flush). A second set of growth promotion sites may then be formed on the same substrate, optionally in respect of the same or different species of polypeptide molecules.

In a fifth aspect, the present invention provides a method of detecting a species of polypeptide molecule in a sample fluid, including the steps:
providing an acoustic wave transducer substrate having a surface with a plurality of growth promotion sites for promoting the accumulation of polypeptide molecules at said sites;
causing oscillation of the substrate;
contacting said surface with a sample fluid; and
measuring one or more parameters of the substrate oscillation,
   wherein the method is used to determine the presence or absence of the species of polypeptide molecule in the sample fluid, said species of polypeptide molecule, if present, causing accumulation of polypeptide molecules and thereby altering at least one parameter of substrate oscillation.

The growth promotion sites may comprise seed-fibrils and/or immobilised binding partners capable of specifically binding a polypeptide molecule of interest. Suitable binding partners include antibodies and antibody fragments specific for a polypeptide molecule of interest. The immobilised binding partners are capable of capturing a polypeptide molecule of interest, if present in the sample fluid, and thereby providing a seed fibril for further growth. Said accumulation of polypeptide molecules preferably occurs at said growth promotion sites. The species of polypeptide molecule of interest is preferably capable of forming amyloid fibrils.

Growth of a seed-fibril that lies prone along the substrate surface tends predominantly to provide a variation in the frequency of the oscillation of the substrate. This is because the growing seed-fibril is relatively firmly immobilised on the substrate surface, and thus provides only small (or zero) non-elastic losses that would otherwise affect the phase/dissipation of the substrate oscillation. Accordingly, preferably the measured parameter of the substrate oscillation is the frequency of oscillation. However, the measurement of the phase of the substrate oscillation (i.e. the imaginary part of the oscillation response) or the dissipation of the substrate oscillation may also provide useful data.

Preferably, the method is carried out in vitro. It is preferred that the sample fluid is derived from a biological source. The method of detecting a polypeptide monomer in a sample fluid according to the fifth aspect may include determining the concentration and/or conformational state of the polypeptide monomer in the sample fluid. It has been found that the concentration and the initial conformational state of the polypeptide molecules influence the rate of growth. Preferably the method comprises determining the conformational state of polypeptide molecules from a population of polypeptide molecules, the population including polypeptides of differing conformational state. It has been found that the same seed fibrils can be used to probe different conformational states. This arises from the observation that the accumulation of polypeptide molecules into fibrils is highly conformation-dependent, so that accumulation will be greatly reduced (or avoided altogether) if the peptides have an incorrect conformational state in comparison with the seed-fibrils.

It may be preferred to compare the response of the substrate (or of a substantially identical substrate) to a standard suspension of polypeptide molecules of known conformational state and/or known concentration. This is particularly preferred where the polypeptide molecules of interest in the sample fluid are unknown.

The method may comprise monitoring the interaction of growing fibrils with candidate molecules by including a candidate molecule in a sample fluid and monitoring the oscillation parameters of the substrate. Additionally or alternatively, the method may comprise monitoring the interaction of polypeptide molecules in the sample fluid with candidate molecules, by monitoring the oscillation parameters of the substrate and thereby assessing the effect of the candidate molecule on the seed-fibril growth.

In a sixth aspect, the present invention provides a method of diagnosis of a fibril-related disease in a subject, the method comprising the steps:
providing an acoustic wave transducer substrate having a surface with a plurality of growth promotion sites for promoting the accumulation of disease-associated polypeptide molecules at said sites;
causing oscillation of the substrate;
contacting said surface with a sample fluid derived from the subject; and
measuring one or more parameters of the substrate oscillation,
   wherein alteration of at least one parameter of substrate oscillation indicates accumulation of said disease-associated polypeptide molecules and thereby indicates the presence of, or susceptibility to, a fibril-related disease in the subject.

Said accumulation of polypeptide molecules preferably occurs at said growth promotion sites.

The subject is preferably selected from the group consisting of: livestock mammals, such as sheep and bovines; domestic mammals, such as cats and dogs; and humans. The subject is most preferably human.

The fibril-related disease is preferably a disease characterised by the presence of amyloid fibrillar protein deposits. Such diseases are often termed amyloidoses. The role of amyloid fibrils in different disease states is discussed in: C. M. Dobson “The structural basis of protein folding and its links with human disease” Phil. Trans. R. Soc. Lond. B. 2001, 256, 133-145, which is expressly incorporated herein by reference in its entirety. For example a range of clinical syndromes and corresponding proteins/fibril components are described in tables 1 and 2, therein, and are specifically incorporated herein by reference. The disease may be selected from the group consisting of: Hypercholesterolaemia, cystic fibrosis, phenylketonuria, Huntington's disease, Marfan syndrome, osteogenesis imperfecta, sickle cell anaemia, α1-antitrypsin deficiency, Tay-Sachs disease, scurvy, Alzheimer's disease, Parkinson's disease, scrapie, BSE, Creutzfeldt-Jakob disease, familial amyloidoses, retinitis pigmentosa, cataracts, cancer, spongiformencephalopathies, primary systemic amyloidosis, secondary systemic amyloidosis, familial amyloidotic poly neuropathy I, senile systemic amyloidosis, hereditary cerebral amyloid angiopathy, haemodialysis-related amyloidosis, familial amyloidotic polyneuropathy II, Finnish hereditary amyloidosis, Type II diabetes, medullary carcinoma of the thyroid, Atrial amyloidosis, Lysozyme amyloidosis, Insulin-related amyloid and Fibrinogen α-chain amyloidosis. More preferably, the disease is Alzheimer's disease, BSE, Type II diabetes, Creutzfeldt-Jakob disease, Parkinson's disease or Huntington's disease.

In this and all other aspects of the invention, the polypeptide molecule of interest is preferably a fibril-related disease-associated polypeptide. Said disease-associated polypeptide molecules are polypeptide molecules associated with a particular fibril-related disease. Preferred disease-associated polypeptide molecules are described in C. M. Dobson “The structural basis of protein folding and its links with human disease” Phil. Trans. R. Soc. Lond. B. 2001, 256, 133-145. For example, beta-amyloid peptide (Aβ 1-40, Aβ 1-42 and/or Aβ 1-43) is associated with Alzheimer's disease; prion protein is associated with transmissible spongiform encephalopathies (TSEs) including Creutzfeldt-Jakob disease (Human), BSE (Bovine) and scrapie (Ovine); Amylin/Islet associated polypeptide is associated with Type II diabetes. It is contemplated that the methods of the invention may include screening a subject for more than one fibril-related disease.

The method according to the sixth aspect is preferably carried out in vitro. The method may include determining the concentration and/or conformational state of one or more of the disease-associated polypeptide molecules present in the sample fluid derived from the subject.

As in the fifth aspect, the growth promotion sites may comprise seed-fibrils and/or immobilised binding partners capable of specifically binding a disease-associated polypeptide molecule. Suitable binding partners include antibodies and antibody fragments specific for a disease-associated polypeptide molecule. The immobilised binding partners are capable of capturing a disease-associated polypeptide molecule, if present, in the sample fluid and thereby providing a seed fibril for further accumulation of disease-associated polypeptide molecules.

It is of particular interest to be able to investigate the presence of species in a sample fluid that may act as seeds or nuclei for aggregation, and therefore fibril growth. However, such species are likely to be present only in very low concentrations in the sample fluid. Accordingly, prior to the steps outlined in the sixth aspect, the sample fluid may undergo a pre-treatment step. The pre-treatment step preferably includes adding a known quantity of characterised polypeptide molecules to the sample fluid. In the absence of suitable seeds or nuclei for aggregation, the characterised polypeptide molecules typically will not aggregate. However, in the presence of suitable seeds or nuclei for aggregation, the seeds or nuclei grow by addition of the characterised polypeptide molecules. This pre-treatment step may also include at least one disruption step, in which the growing fibrils are caused to fracture. Sonication (e.g. at ultrasound frequencies) is suitable. Fracture of the growing fibrils provides new growth sites for further growth. Further fracture and further growth provides a route for amplifying the number of seeds or nuclei for aggregation, analogous to PCR (polymerase chain reaction) techniques.

The seed-fibrils in the pre-treated sample fluid may then be allowed to adsorb onto the acoustic transducer substrate at growth promotion sites (e.g. at immobilised binding partners on the substrate surface). Exposure of the substrate to a known concentration of characterised polypeptide molecules that can aggregate onto the seed-fibrils then allows investigation of the presence of the seed-fibrils by measuring at least one parameter of the substrate oscillation.

In a seventh aspect, the present invention provides a method of screening a candidate compound for an effect on fibril growth, the method comprising the steps:
providing an acoustic wave transducer substrate having a surface with a plurality of growth promotion sites for promoting the accumulation of polypeptide molecules at said sites;
causing oscillation of the substrate;
contacting said surface with a sample fluid comprising polypeptide molecules and a candidate compound; and measuring one or more parameters of the substrate oscillation to monitor the accumulation of said polypeptide molecules of interest in the presence of and in the absence of said candidate compound,
   wherein alteration of the accumulation of said polypeptide molecules of interest in the presence of said candidate compound as compared with that in the absence of said candidate compound indicates that the candidate compound has an effect of fibril growth.

Preferably, the polypeptide molecule is a fibril related disease-associated polypeptide. More preferably, the polypeptide molecule is beta-amyloid peptide, prion protein, insulin or amylin. The method is preferably for screening a candidate compound for an inhibitory effect on fibril growth. Preferred candidate compounds include compounds suspected of interfering with the accumulation of disease-associated polypeptide molecules into fibrils.

The method may additionally comprise the steps of isolating a candidate compound found to have an effect on fibril growth and providing a combination of said candidate compound and at least one pharmaceutically acceptable excipient.

In an eighth aspect, the present invention provides a method for detecting fibril fracture, the method comprising the steps:
providing an acoustic wave transducer substrate having a surface with a plurality of growth promotion sites for promoting the accumulation of polypeptide molecules into fibrils at said sites;
causing oscillation of the substrate;
contacting said surface with a sample fluid comprising polypeptide molecules; and
measuring one or more parameters of the substrate oscillation to monitor fibril growth,
   wherein the monitoring of fibril growth includes detection of the fracture of a growing fibril.

Fibril fracture is believed to influence the kinetics of growth and degradation of amyloid fibrils. Fibril fracture is, therefore, an important element of disease progression in fibril-related diseases.

Preferred embodiments of the invention will now be set out, by way of example, with reference to the accompanying drawings, in which:

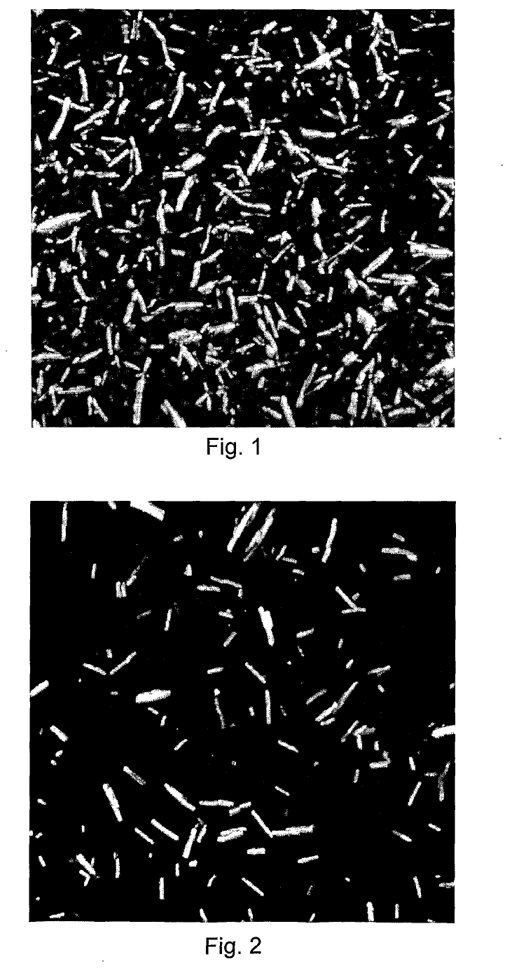

FIG. 1 shows an atomic force microscope (AFM) image of insulin seed-fibrils on a gold-coated substrate (imaged area is 2×10⁻⁶ m in width).

FIG. 2 shows an AFM image of insulin seed-fibrils on a mica substrate (imaged area is 2×10⁻⁶ m in width).

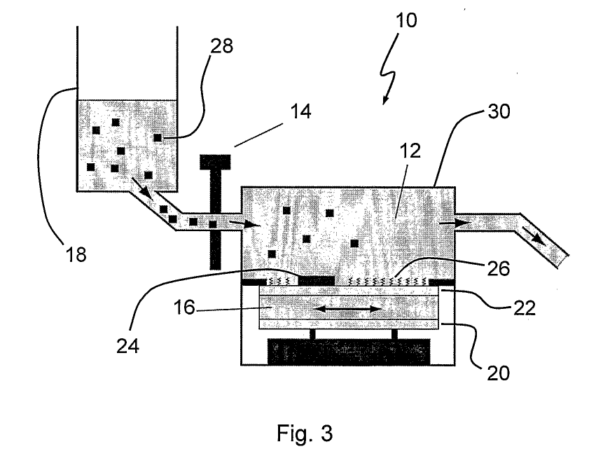

FIG. 3 shows a schematic view of an apparatus for carrying out an embodiment of the invention.

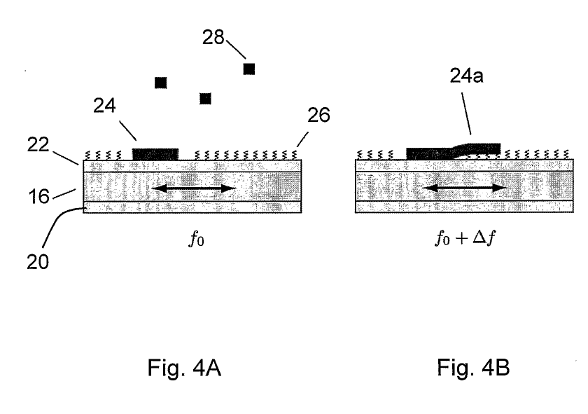

FIGS. 4A and 4B show a schematic progressive views of fibril growth from a seed-fibril on a substrate according to an embodiment of the invention.

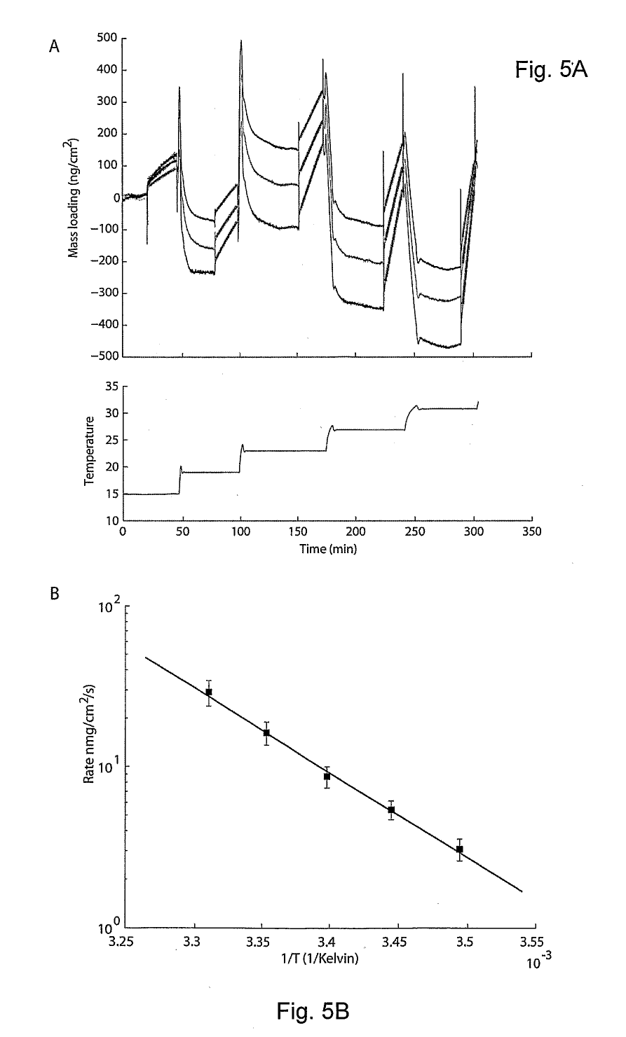

FIGS. 5A and 5B show a series of related graphs illustrating test results of an embodiment of the invention.

In the present work, insulin fibrils are used as a model system. This system, and particularly the formation of fibrils from insulin molecules, has been discussed in detail in José L. Jiménez, Ewan J. Nettleton, Mario Bouchard, Carol V. Robinson, Christopher M. Dobson and Helen R. Saibil, “The protofilament structure of insulin amyloid fibrils”, PNAS, Jul. 9, 2002, Vol. 99 No. 14, 9196-9201, the content of which is incorporated herein by reference in its entirety.

It has been determined that insulin fibrils tend to adopt a prone morphology when allowed to adsorb onto a gold-coated quartz crystal microbalance (QCM) substrate. An AFM image of insulin fibrils on a gold-coated QCM substrate is shown in FIG. 1. As can be seen here, the fibrils tend to lie with their principal, elongate axes substantially parallel with the surface of the substrate. It is postulated that this is assisted by the presence of thiol groups on the fibrils, the interaction of these groups with the gold causing a minimisation of free energy when the fibrils lie flat against the gold surface as shown in FIG. 1.

Similarly, it has also been determined that fibrils tend to adopt a prone morphology when allowed to settle on other flat substrates. As an example, FIG. 2 shows an AFM image of insulin fibrils on a mica substrate. Properly prepared mica substrates can be very flat (as shown by the lack of background undulation in FIG. 2 compared to FIG. 1).

The use of a quartz crystal microbalance (QCM) is well known in the field of biological analysis. This standard laboratory technique uses a device with a planar quartz substrate in which surface acoustic waves are generated across an active surface region through the piezoelectric effect, such waves being stimulated electrically through a set of pre-formed electrodes. As these surface waves traverse the surface region of the substrate they undergo a shift in frequency and dissipation; the former being a direct measure of the mass attached to the substrate surface, the latter being a measure of the non-elastic losses of material attached to the surface, e.g. viscous damping.

A schematic view of a QCM apparatus 10 according to an embodiment of the invention is shown in FIG. 3. The sensor substrate 16 has a lower electrode 20 formed from gold and an upper electrode 22 formed from gold. Application of a suitable varying electric field across the substrate causes the substrate to oscillate via the piezoelectric effect.

A sample fluid 12 is contained in a reservoir 18. This fluid is allowed to flow past and in contact with the upper surface of the upper electrode 22 in a flow cell 30, the flow being controlled by control valve 14 between the reservoir 28 and the flow cell 30.

The preparation of the substrate will now be described in more detail, with reference to FIGS. 3, 4A and 4B. The gold electrodes are fabricated by known techniques, such as DC sputtering. On the upper electrode surface is formed an array of growth promotion sites, by depositing a corresponding array of seed fibrils. Suitable seed-fibrils are formed from the fibrils of interest (i.e. the fibrils to be studied) by ultrasonication of an aqueous suspension of fibrils. Typically, the average length of the fibrils is reduced to around 100 nm. This provides a corresponding increase in the number of free ends for allowing for fibril growth (for a particular mass of starting fibrils) and so increases the signal-to-noise ratio of the measurement, which is described later.

The seed-fibrils are deposited onto the upper surface of the upper electrode and are left to adsorb over 60 minutes in a humidity controlled environment (100% humidity). It has been determined by AFM measurements that the seed-fibrils lie along the surface of the electrode (see FIG. 1). This is considered to be due to energetic effects, certain groups (e.g. thiol groups) preferentially adsorbing onto the gold surface, and the relatively large aspect ratio of the seed fibril therefore favouring a prone position on the gold surface.

The seed-fibrils tend to deposit randomly on a flat electrode surface (see FIG. 1). However, it is possible to deposit seed fibrils onto a nanoengineered electrode surface. For example, grooves or ridges may be formed in the electrode surface by nanolithography, using techniques that are well known to the skilled person. In that case, seed-fibrils tend to deposit aligned with the grooves or ridges. Furthermore, fibril growth tends also to be aligned with the grooves or ridges.

Additionally or alternatively, it is possible to cause the seed-fibrils to be arranged in a pattern. For example, the seed-fibrils may be micro- or nano-contact printed, or inkjet printed, onto the electrode surface, so that seed-fibrils are only deposited at the places of contact between a printing tool and the electrode surface. In another embodiment, the seed-fibrils may be deposited as above, but the as-deposited seed-fibrils may then be patterned by selective etching of the spaces between the desired growth promotion sites. Such patterning techniques will be well known to the skilled person.

Using the patterning techniques set out above, it is possible to gauge more precisely the number of growth promotion sites per unit area. For a standardised deposition and patterning protocol, the reproducibility of such a protocol could be measured via AFM measurements, for example. Knowledge of the areal density of growth promotion sites allows the results of QCM measurements to be interpreted more easily.

It is also possible to replace the seed-fibrils with suitable immobilised binding partners in order to promote the nucleation of fibrils, as will be clear to the skilled person in the light of this disclosure.

After deposition of the growth promotion sites, a barrier layer is formed in the spaces of the electrode surface between the growth promotion sites. The barrier layer is formed from a PEG-derived monolayer, each molecule having a thiol group formed at one end for adsorption onto the gold surface. The PEG layer is deposited so that it self-assembles into a monolayer on the gold surface by interaction between the thiol groups of the PEG and the gold surface, in a well-known manner.

The barrier layer only attaches to the bare gold surface it does not attach at the growth promotion sites. The result, as shown in FIG. 3, is an array of growth promotion sites 24 separated from each other by a barrier layer 26.

During the measurement, the fluid 12 containing peptide “monomer” 28 (i.e. peptide fragments that can accumulate at the seed-fibril and cause growth of the seed-fibril) is caused to flow past the seed-fibrils. The test fluid 12 may also contain chemical and/or biological species that are aimed at affecting fibril growth or other characteristics of the fibril response. Within the flow cell, the peptide monomers may attach to the seed-fibrils but substantially do not non-selectively adsorb onto the barrier layer surface. Avoiding such non-selective adsorption allows the measured changes in the oscillation characteristics of the QCM device to be attributed to events occurring at the growth promotion sites.

As shown in FIGS. 4A and 4B, growth of the fibril occurs by extension of the seed-fibril onto and along the surface of the barrier layer 26, forming an elongated fibril 24a. Over a large number of seed fibrils, the change in mass attached to the surface causes a detectable change in the frequency of the surface acoustic waves of the substrate.

### EXAMPLE

The growth of insulin onto insulin-seeded sites on a QCM substrate was studied using the technique described above.

In order to determine the growth kinetics of specific fibrils the real and imaginary frequency response as measured by a QCM is recorded as the growth proceeds once monomer has been injected into the fluid cell. This is repeated at a series of temperatures so that a plot of log (mass increase per unit area per unit time, \dot{m}) versus 1/temperature yields a straight line curve whose gradient is the activation energy E_{act} for growth and hence a direct measure of the kinetics.

$$\dot{m} = {\dot{m}}_{o} exp [ \frac{{E}_{act}}{kT} ]$$

The results of the measurements (performed at 5 different temperatures) are shown in FIG. 5A. The lower graph is a plot of the flow cell temperature against time and the upper plot is a plot of the mass loading of the QCM substrate (determined by the change in oscillation characteristics of the substrate) against time.

During the measurement, a suspension of insulin monomers was introduced into the flow cell at specific temperatures. As shown by the upper graph in FIG. 5A, after the growth and temperature had stabilised the mass increased monotonically at a temperature of 15° C. The temperature of the cell is then increased (as shown in the lower graph of FIG. 5A) and the mass increase observed again. The rate of mass increase for each of the temperatures was then measured from FIG. 5A and re-plotted in FIG. 5B as an Arrhenius plot. The activation energy (i.e. the energy barrier to fibril elongation) for the insulin fibrils was measured to be 1.1 eV; the first time such a rate has been determined in such a straightforward, reproducible and routine way without the need to attach probe molecules.

As will be clear to the skilled person, a candidate compound or biological species can be included in the test fluid. Such a candidate compound or species would be chosen with a view to assessing its effect on the growth of seed fibrils, compared to in the absence of the compound or species, using the testing protocol set out above.

It is considered that the conformation state of the peptide monomers may have a critical influence on the rate of growth of the fibrils. Accordingly, embodiments of the invention can be envisaged by the skilled person in which different conformation states of the peptide monomers are used at similar concentrations in different measurements in order to assess the activation energy and/or growth rate, optionally in the presence of a candidate compound or species.

It is possible to provide more than one type of seed-fibril (or other growth promotion site) on the QCM substrate. In this way, the same substrate can be used to carry out more than one measurement, either at the same time or sequentially. If the measurements are to be carried out sequentially (as is preferred for the sake of ease of interpretation of the measurement results), the sensing areas of the substrate not being used in a particular measurement may be blanked off for the duration of that measurement. This may be carried out by lithographic techniques (optical, imprint or inkjet, for example). Alternatively, the target regions may be chemically sensitised so that a specific reaction takes place that places a monolayer at the selected region.

Furthermore, it is possible to operate more than one QCM substrate in parallel, in contact with the same test fluid. In this way, a parallel set of results may be obtained for the same fluid, for different growth promotion sites.

In another embodiment, a single QCM substrate may have more than one sensing area formed on it, each sensing area being provided with a corresponding arrangement of electrodes. Suitable techniques for forming such a structure will be well known to the skilled person, for example from JP-A-2003-240694, which uses multiple sensing areas. In the present embodiment, each sensing area has different growth promotion sites, thereby making each sensing area specific to a different polypeptide molecule that may be present in the sample fluid, or making each sensing area specific to a different interaction between a candidate compound and the growth promotion site or the polypeptide molecules in the sample fluid. One or more of the sensing areas may be a control, with no growth promotion sites, or with inactivated growth promotion sites. With such an arrangement, it is possible to operate the sensing areas in parallel by operating them at different frequencies. Given that a typical QCM device operates at a frequency of the order of 10 MHz, offsetting different sensing areas by a few kHz is practicable, and it is found that the operation of the sensing areas in this way in parallel does not cause interference between them. In this way, multiple channel data may be generated from the same sample fluid under the same conditions, speeding up the process and avoiding problems caused by taking measurements in series, such as temperature differences between the series measurements.

In a further development, the QCM substrate may be printed with the required array of growth promotion sites in an automated device. Such a substrate may be re-used by removing the growth promotion sites, fibril growth and barrier layer via a solvent flush.

In order to develop a diagnostic test for an amyloid plaque related disease, it is possible selectively to adsorb seeds of misfolded proteins present in body fluid onto the QCM substrate. For example, immobilised antibodies may be used to bind to such seeds. The seeded substrate may then be exposed to known concentrations of specific peptide monomers in order to measure the growth rate and/or activation energy (as set out above) in order to determine the concentration of the potentially pathogenic seeds.

In many cases, it is to be expected that the concentrations of seeds in a sample fluid will be very low. In order to amplify the number of such seeds, it is possible to carry out an amplification step analogous to that described in Gabriela P. Saborio, Bruno Permanne, Claudio Soto, “Sensitive detection of pathological prion protein by cyclic amplification of protein misfolding”, Nature 411, 810-813 (14 Jun. 2001). In this reference, the concentration of the principal component of prions, the glycoprotein PrP(Sc) (a conformationally modified isoform of a normal cell surface protein PrP(C)) in a sample fluid is amplified by adding an excess of PrP(C) and incubating to allow growth of the PrP(Sc) seeds. The aggregates of PrP(Sc) formed are disrupted by sonication to form multiple smaller units for the continued formation of new PrP(Sc).

In the present embodiment, it is instructive first to consider a control test fluid in which only a suspension of insulin is provided. In the absence of external influences, insulin fibrils will not form. However, if such a test fluid is added to a sample fluid containing seed-fibrils of insulin, the insulin molecules will aggregate onto the seeds, causing growth of the fibrils. Sonication of the growing fibrils causes them to break, thereby providing an increased number of seeds for further growth. Provided that there remains an excess of insulin, growth will continue, thereby amplifying the concentration of insulin seed-fibrils. After suitable amplification, the sample fluid may then be exposed to a substrate having growth promotion sites with immobilised binding partners for insulin seed-fibrils. Subsequently, the oscillation response of the substrate can be tested when exposed to a fluid having a known concentration of insulin, in order to assess the mass accumulation response of the substrate, and therefore assess the presence or absence of seeds in the original sample fluid. As will be clear to the skilled person, this protocol may be applied to fibrils other than insulin fibrils when a solution of suitable polypeptide molecules for causing growth of the fibrils can be provided, both for the amplification step and for the measurement step.

Preferred embodiments of the invention have been described by way of example. Modifications of these embodiments, further embodiments and modifications thereof will be apparent to the skilled person on reading this disclosure and as such are within the scope of the present invention.

1. An acoustic wave transducer substrate having a surface with a plurality of growth promotion sites for promoting the accumulation of polypeptide molecules at said sites.

2. An acoustic wave transducer substrate according to claim 1 which is a quartz crystal microbalance sensor

3. An acoustic wave transducer substrate according to claim 1 wherein said growth promotion sites are for promoting fibril formation.

4. An acoustic wave transducer substrate according to claim 1 wherein said growth promotion sites are provided with seed-fibrils.

5. An acoustic wave transducer substrate according to claim 4 wherein the seed fibrils have an average length of 1 μm or less.

6. An acoustic wave transducer substrate according to claim 1 wherein said growth promotion sites are each provided with an immobilised binding partner capable of specifically binding a polypeptide molecule of interest.

7. An acoustic wave transducer substrate according to claim 6 wherein said immobilised binding partner comprises an antibody or antibody fragment specific for a polypeptide molecule of interest.

8. An acoustic wave transducer substrate according to claim 1 wherein a barrier layer is provided on the substrate in spaces between the growth promotion sites.

9. An acoustic wave transducer substrate according to claim 8 wherein the barrier layer is formed from polyethylene glycol having a thiol group formed at one end for binding to the substrate surface.

10. An acoustic wave transducer substrate according to claim 1 wherein the growth promotion sites are arranged in a regular array on the substrate surface.

11. An acoustic wave transducer substrate according to claim 1 wherein said substrate is provided with a seeding-controlling, growth-promotion or growth-controlling topography.

12. A method of treating an acoustic wave transducer substrate in order to provide a plurality of growth promotion sites for promoting the growth of polypeptide molecules at said sites, the method including depositing seed-fibrils at said growth-promotion sites.

13. A method according to claim 12 wherein said seed-fibrils are deposited onto the substrate surface by adsorption over a period of at least 10 minutes.

14. A method according to claim 12 wherein said seed-fibrils are deposited onto the substrate surface in a humidity-controlled environment.

15. A method of treating an acoustic wave transducer substrate in order to provide a plurality of growth promotion sites for promoting the growth of polypeptide molecules at said sites, the method including depositing binding partners specific for a polypeptide molecule of interest at said growth-promotion sites.

16. A method according to claim 12 wherein a barrier layer is provided in the areas between the growth promotion sites.

17. An acoustic transducer substrate treatment apparatus comprising a deposition device for forming a plurality of growth promotion sites on a substrate, which growth promotion sites are for promoting the accumulation of polypeptide molecules at said sites.

18. An acoustic transducer substrate treatment apparatus according to claim 17 wherein said deposition device comprises an inkjet printing mechanism.

19. A method of detecting a species of polypeptide molecule in a sample fluid, including the steps:
providing an acoustic wave transducer substrate having a surface with a plurality of growth promotion sites for promoting the accumulation of polypeptide molecules at said sites;
causing oscillation of the substrate;
contacting said surface with a sample fluid; and
measuring one or more parameters of the substrate oscillation,
wherein the method is used to determine the presence or absence of the species of polypeptide molecule in the sample fluid, said species of polypeptide molecule, if present, causing accumulation of polypeptide molecules and thereby altering at least one parameter of substrate oscillation.

20. A method of diagnosis of a fibril-related disease in a subject, the method comprising the steps:
providing an acoustic wave transducer substrate having a surface with a plurality of growth promotion sites for promoting the accumulation of disease-associated polypeptide molecules at said sites;
causing oscillation of the substrate;
contacting said surface with a sample fluid derived from the subject; and
measuring one or more parameters of the substrate oscillation,
wherein alteration of at least one parameter of substrate oscillation indicates accumulation of said disease-associated polypeptide molecules and thereby indicates the presence of, or susceptibility to, a fibril-related disease in the subject.

21. A method of diagnosis according to claim 20 wherein said fibril-related disease is selected from the group consisting of: Alzheimer's disease, Creutzfeldt-Jakob disease, type II diabetes, bovine spongiform encephalopathy and scrapie.

22. A method according to claim 20 which is carried out in vitro.

23. A method according to claim 19 wherein the measured parameter of the substrate oscillation is the frequency of oscillation.

24. A method according to any claim 19 wherein said growth promotion sites are provided with seed-fibrils.

25. A method according to claim 19 wherein said growth promotion sites are each provided with an immobilised binding partner capable of specifically binding a polypeptide molecule.

26. A method of screening a candidate compound for an effect on fibril growth, the method comprising the steps:
providing an acoustic wave transducer substrate having a surface with a plurality of growth promotion sites for promoting the accumulation of polypeptide molecules at said sites;
causing oscillation of the substrate;
contacting said surface with a sample fluid comprising polypeptide molecules and a candidate compound; and
measuring one or more parameters of the substrate oscillation to monitor the accumulation of said polypeptide molecules of interest in the presence of and in the absence of said candidate compound,
wherein alteration of the accumulation of said polypeptide molecules of interest in the presence of said candidate compound as compared with that in the absence of said candidate compound indicates that the candidate compound has an effect of fibril growth.

27. A method according to claim 26 additionally comprising the steps of isolating a candidate compound found to have an effect on fibril growth and providing a combination of said candidate compound and at least one pharmaceutically acceptable excipient.

28. A method for detecting fibril fracture, the method comprising the steps:
providing an acoustic wave transducer substrate having a surface with a plurality of growth promotion sites for promoting the accumulation of polypeptide molecules into fibrils at said sites;
causing oscillation of the substrate;
contacting said surface with a sample fluid comprising polypeptide molecules; and
measuring one or more parameters of the substrate oscillation to monitor fibril growth, wherein the monitoring of fibril growth includes detection of the fracture of a growing fibril.
